(19) United States
(12) Patent Application Publication
(10) Pub. No.: US 2008/0120237 A1
(43) Pub. Date: May 22, 2008

(54) Method for prevent crime of finance service system using telephone number codes and identification code

(76) Inventor: Chung-Yu Lin, Kaohsiung City (TW)

Correspondence Address: BACON & THOMAS, PLLC, 625 SLATERS LANE, FOURTH FLOOR, ALEXANDRIA, VA, 22314, US

(21) Appl. No.: 11/984,461

(22) Filed: Nov. 19, 2007

Related U.S. Application Data
(60) Provisional application No. 60/859,929, filed on Nov. 20, 2006.

(51) Int. Cl. G06Q 40/00; G06Q 90/00

(52) U.S. Cl. 705/44

(57) ABSTRACT

A method for preventing crimes against financial service providers uses a telephone number code and identification code provided by the account owner to a dealing bank. The telephone number code and identification code are registered and stored in the database of the dealing bank and used as identity-recognizing authorization information for various financial services between the bank and the account owner, in addition to a card number, security code, and the like. Use of the telephone number code and identification code protects both the account owner and the bank by effectively precluding monetary loss from criminal behaviors such as theft, fraudulent withdrawal or fraudulent credit card transactions.

This application claims the benefit of provisional U.S. Patent Application No. 60/859,929, filed Nov. 20, 2006.

### FIELD OF THE PRESENT INVENTION

The present invention provides a method for preventing crimes against financial service providers, in which a telephone number code and identification code provided by the account owner to a dealing bank are registered and stored in the database of the dealing bank and used as identity-recognizing authorization information for various financial services between the bank and the account owner. Use of the telephone number code and identification code protects both the account owner and the bank by effectively precluding monetary loss from criminal behaviors such as theft, fraudulent withdrawal or fraudulent credit card transactions.

### BACKGROUND OF THE INVENTION

As plastic currency has replaced the traditional transaction at the bank teller, a lot of trading activity in financial markets is completed without cash via banking card, credit card and the like. The increasing prevalence and capabilities of computer networks extends the use of the banking card or the credit card to on-line consumption. However, many drawbacks and abuses have also come along with the increasing use of plastic currency in numerous financial transactions, as follows:

(1): The banking card may be lost or stolen carelessly:

Because of strong competition in the banking business, holding many banking cards at the same time is very popular for some people, and criminal cases involving loss of a banking card increase in frequency every year. While theft by withdrawal is impossible for someone who has found or stolen a banking card without knowledge of a security code or the banking card, it is often not difficult to find out the security code from people surrounding the cardholder, such as a friend or colleague having ulterior motives. For example, someone with ulterior motives might covertly follow the cardholder to the ATM and spy on the transaction to obtain the security code during a deposit and withdrawal procedure, and then trail the cardholder and wait for an opportunity to steal and obtain his/her banking card. Alternatively, some cardholders always write the security code on a paper slip and then put it with the banking card together for fear of forgetting the security code of one's own banking card, making it easy to obtain the security code upon obtaining the card. Moreover, many cardholders have the habit of putting personal identity documents (such as an identity card, health insurance card, drivers license, student identity card, employee card, etc.) together with the banking card in the same leather wallet, which will also enable the security code to be obtained if the wallet is picked or stolen by a person, since the person can work out the security code by through repeated trial and error by permutation and combination of the numerical data for the personal identity documents. Accordingly, cases of theft by withdrawal upon illicitly obtaining the security information for banking cards belonging to other people are not uncommon. The victims, who have been suffered from monetary loss due to banking card loss or theft, not only must sigh to oneself about bad luck, but he/she must hurriedly phone each bank one by one to report and register the loss of the banking card and apply to re-issue banking card by going through complicated routines, which might cause significant emotional distress.

(2): A bank account may be illicitly used by a financial criminal with a banking card:

The number of financial crime cases has increased year by year, and government and bankers are all eager to set up precautionary measures such as requiring a second identity certificate upon opening an account, establishing an upper daily limit for ATM and transferring transaction amounts, strengthening prosecution of financial crimes, re-educating financial staff in recognizing financial crimes, and supporting investigation and arrest for fraudulent dummy accounts and cancellation of notification. However, scams involving transferring accounts via a fraudulent dummy account (namely a fake or phony account) still happen frequently. What really upsets police is that some criminals cooperate with a computer expert to hijack the bank account of other people via the network (Internet) and circuitously divert funds to another middle account (not a fraudulent dummy account), and then remit the funds into the criminal account. Sometimes, in order to increase the degree of difficulty of police pursuit and capture, the number of middle accounts might be increased purposely and result in affecting some innocent account owners, who then may suffer unjust detention, accusation and torment from being a suspected accomplice. All these crime committing types become an obstacle for numerous internet banks and users, who engaged in business activity over the network.

(3): The credit card may be lost carelessly, stolen or forged:

To pay daily expenses for food, clothes, housing, transportation, education and entertainment by credit card has already become a modern general consumption pattern; Additionally, due to bank promotions and favorable commercial strategies in issuing credit cards, holding many credit cards simultaneously has become very popular for most people. Thus, people whose credit card is carelessly lost or stolen frequently become the target of a financial criminal, who will go shopping for commodities that can be converted into cash using the illicit credit card. The victimized credit card holder, who has suffered monetary loss due to the credit card being lost or stolen, is not only obliged to phone the credit card issuing bank to report and register the loss of the credit card, but also is bothered by the inconvenient and awkward situation of having no credit card available, at least temporarily, which might cause miscellaneous emotional distress. In case of having a credit card of his own been forged by a criminal group, the victim will be subjected to suspicion of being involved in the criminal enterprise of forging the document. Despite the widespread nature of the problem, and efforts at enforcement, the number of credit card fraudulent criminal cases involving forging, stealing or fraudulent transactions continues to increase rather than decrease. Why? That is the driving force that has motivated the inventor of the present invention. FIG. 1 is a block diagram of the application procedure for a conventional credit card. When the credit card holder 10 goes to a shop or the internet, labeled as dealing target 1, to carry out a “credit card transaction” or “on-line credit card transaction”, after sending a “request for authorization” initiated by the shop or internet dealing target 1 to the credit card issuing bank 2, the internal bank CPU mainframe in the credit card issuing bank 2 will check the credit information such as credit card number and the transaction amount against an account balance or the like associated with the credit card holder 10. Normally, if all the conditions for authorizing a transaction are met, not only is an instruction of “authorization is granted” sent to the shop or internet dealing target 1, but also a message of “successful credit card transaction” will be displayed on the handling machine of the credit card transaction or the web-page of the shop or internet dealing target 1. Conversely, if any condition does not meet the conditions for authorization, not only is an instruction of “authorization is not granted” sent to the shop or internet dealing target 1, but also a message of “failed credit card transaction” will be displayed on the handling machine of the credit card transaction or the web-page of the shop or internet dealing target 1. In the aforesaid procedure for carrying out a credit card transaction, the cashier can only check the resemblance of handwriting between the signature on the sheet of credit card transaction and that existing on the credit card. Usually, the cashier will complete the transaction as long as both of the signatures do not differ too much from each other. However, to a criminal carrying out a fraudulent online credit card transaction, to counterfeit a signature is an easy task. If a criminal practices the signature handwriting by imitating it several times before proceeding with the fraudulent online credit card transaction, he/she can always successfully cheat the cashier. Even worse, for an “on-line credit card transaction” which does not have algorithm for recognizing and checking the signature handwriting, the transaction will be permitted to proceed as long as the credit card number and a valid expiration date have been input. From this viewpoint, no simple and reliable algorithm or mechanism to serve as a preclusive measure to counteract fraudulent online credit card transactions exists, and it is no surprise that the rate of fraudulent online credit card transactions, either from a true credit card or a forged credit card, has constantly increased.

### SUMMARY OF THE INVENTION

The primary object of the present invention is to provide a method for preventing crimes involving a financial service system using telephone number codes and an identification code, wherein, other than information on personal identity and the like, the exclusive identity-recognizing authorization information includes a proprietary telephone number code and identification code, which is provided by the account owner to the dealing banking institute, is registered and is stored in an authorization database of an existing internal computer system in the dealing banking institute. When the dealing banking institute handles various financial services such as deposit, withdrawal and remittance either at the bank teller or by a banking card at the ATM and the like for the account owner, the banking computer system not only checks all the information of personal identity and the like, but also simultaneously compares the consistency of the exclusive identity recognizing authorization information including the proprietary telephone number code and identification code registered and stored in the database. As a result, the dealing banking institute not only can assure whether the financial service transaction is certainly conducted and finished under genuine authorization by the account owner, but also further can preclude criminal behaviors of thieving withdrawal, fraudulent withdrawal or fraudulent credit card transaction resulting from loss or theft of identity information or the banking card with the security code.

The other object of the present invention is to provide a method for preventing crimes involving a financial service system using telephone number codes and an identification code, wherein, other than the personal identity information and the like, the exclusive identity recognizing authorization information again includes a proprietary telephone number code and identification code, which is provided by the account owner to the dealing banking institute, is registered and is stored in an authorization database of an existing internal computer system in the dealing banking institute, and wherein when the dealing banking institute handles various financial services such as credit card transaction or credit on-line transaction and the like for the account owner with credit card, the banking computer system not only checks all the information of personal identity and the like, but also simultaneously compares the consistency of the exclusive identity recognizing authorization information including the proprietary telephone number code and identification code registered and stored in the database. Thereby, the dealing banking institute not only can assure whether the credit transaction is securely conducted and completed with a genuine authorization by the account owner, but also further can preclude criminal behaviors of thieving withdrawal, fraudulent withdrawal or fraudulent credit card transactions resulting from the credit card being carelessly lost or stolen.

### BRIEF DESCRIPTION OF THE DRAWINGS

FIG. 1 is a block diagram of the application procedure for the conventional credit card.

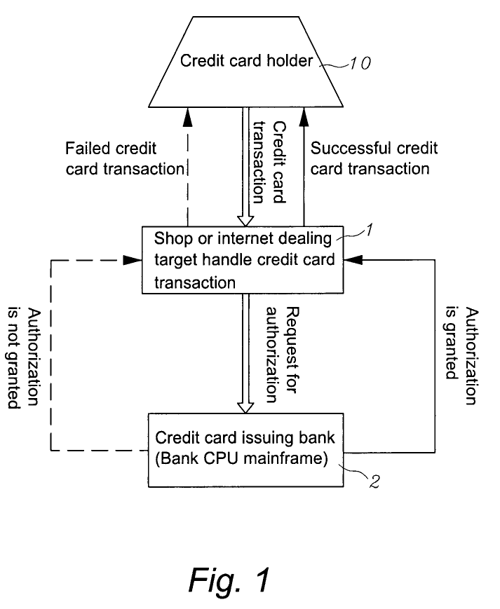

FIG. 2 is a block diagram of the operation steps for the present invention.

FIG. 3 is a first flow chart of the financial service operation at the bank teller for a preferred embodiment of the present invention.

FIG. 4 is a second flow chart of the financial service operation at the bank teller for the preferred embodiment of the present invention.

FIG. 5 is a first flow chart of the financial service operation at the ATM for the preferred embodiment of the present invention.

FIG. 6 is a second flow chart of the financial service operation at the ATM for the preferred embodiment of the present invention.

FIG. 7 is a first flow chart of the financial service operation at the internet remittance via on-line transferring account for the preferred embodiment of the present invention.

FIG. 8 is the second flow chart of the financial service operation at the internet remittance via on-line transferring account for the preferred embodiment of the present invention.

FIG. 9 is the block diagram of the financial service operation steps at the credit card application for the preferred embodiment of the present invention.

FIG. 10 is the flow chart of the financial service operation steps at the credit card application for the preferred embodiment of the present invention.

### DETAILED DESCRIPTION OF THE PREFERRED EMBODIMENTS

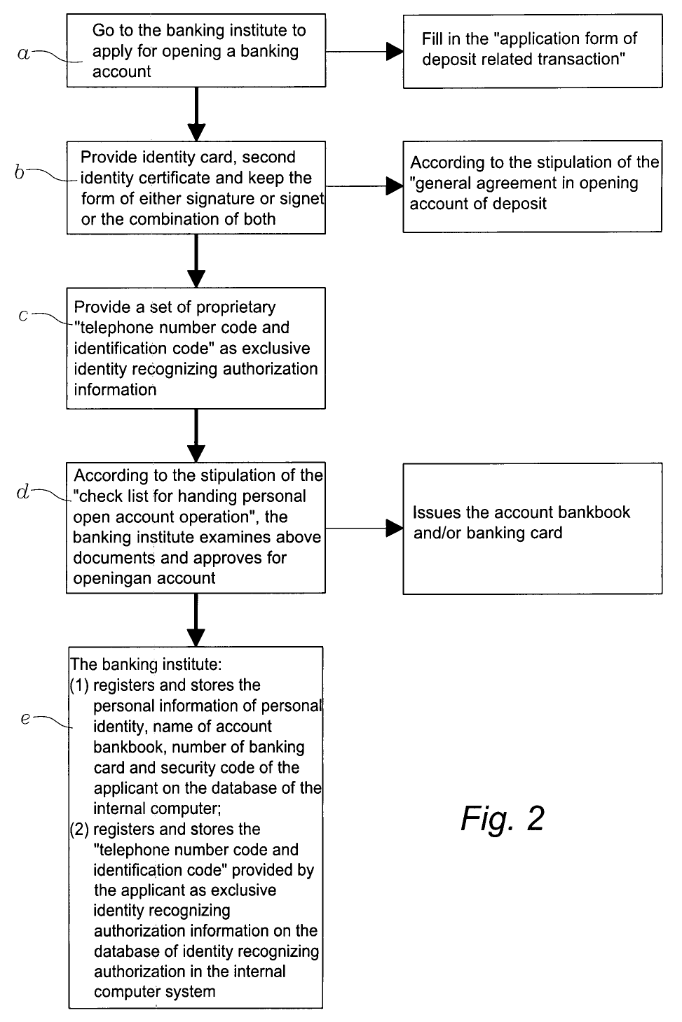

As shown in the FIG. 2, the block diagram of the operation steps in the method for preventing crime involving a financial service system using telephone number codes and identification code according to the present invention comprises the steps of:

(a): a customer going to the banking institution to apply for opening a banking account by filling in the “application form of deposit related transaction”.

(b): the customer/applicant providing an identity card and second identity certificate, and keeping the form of either a signature or signet (or combination of both) in accordance with the stipulation of the “general agreement in opening account of deposit”.

(c): the customer/applicant providing a proprietary “telephone number code and identification code” to the banking institute as exclusive identity recognizing authorization information.

(d): According to the stipulation of the “check list for handling open account operation”, the banking institute examines the above documents, then approves and issues the account bankbook and/or banking card.

(e): The banking institute not only registers and stores the personal information of personal identity, the name of the account bankbook, and the number of the banking card and security code of the applicant in the database of the internal computer, but also registers and stores the telephone number code and identification code provided by the applicant as exclusive identity recognizing authorization information in a corresponding database in the internal computer system.

Those skilled in the art will appreciate that the documents or examining criterion in the “application form of deposit related transaction”, “general agreement in opening account of deposit” and “check list for handling open account operation” mentioned on the foregoing steps, including all the items and clauses in the form or content thereof, are stipulated by each banking institute itself in accordance with the laws of country to which it belongs. The terms or nomenclature might be different from banking institution to banking institution, to which country it belongs, but the spirit and essence of the standard in the related laws is equivalent to each other and should be declared beforehand.

The “telephone number code” in the above-mentioned step (c) is any one of the fixed line network telephone numbers in the household or office of the applicant, namely the account owner, or a personal cellular phone number, fixed line network telephone number with country code plus area code, or personal cellular phone number with country code of the applicant/account owner. Besides, the “identification code”, which is formed from any category or combination of more than two categories of characters, numbers and symbols input from a computer keyboard, can also be arbitrarily amended or changed at anytime by the applicant, namely account owner himself/herself without any necessity for consulting with anyone in accordance with the procedures and methods set by the banking institution after being provided, registered and stored.

Moreover, the internal “database of identity recognizing authorization” in step (e) aforesaid can be changed into an “external database of identity recognizing authorization,” which is created in another external computer system out of the operating range of the internal computer system of the banking institute, so as to reduce the maintenance cost in the internal computer system of the banking institute.

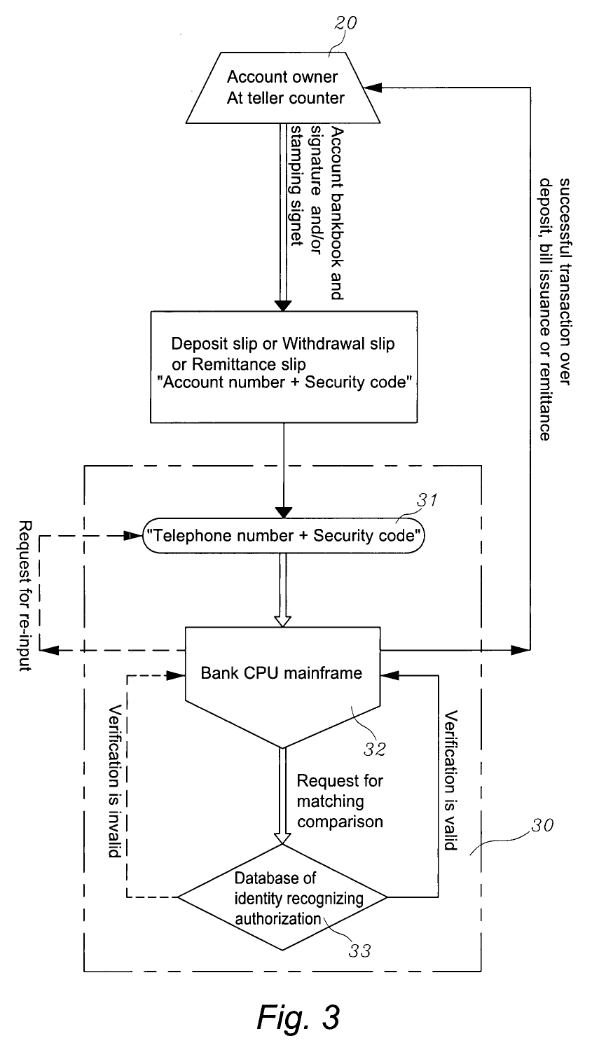

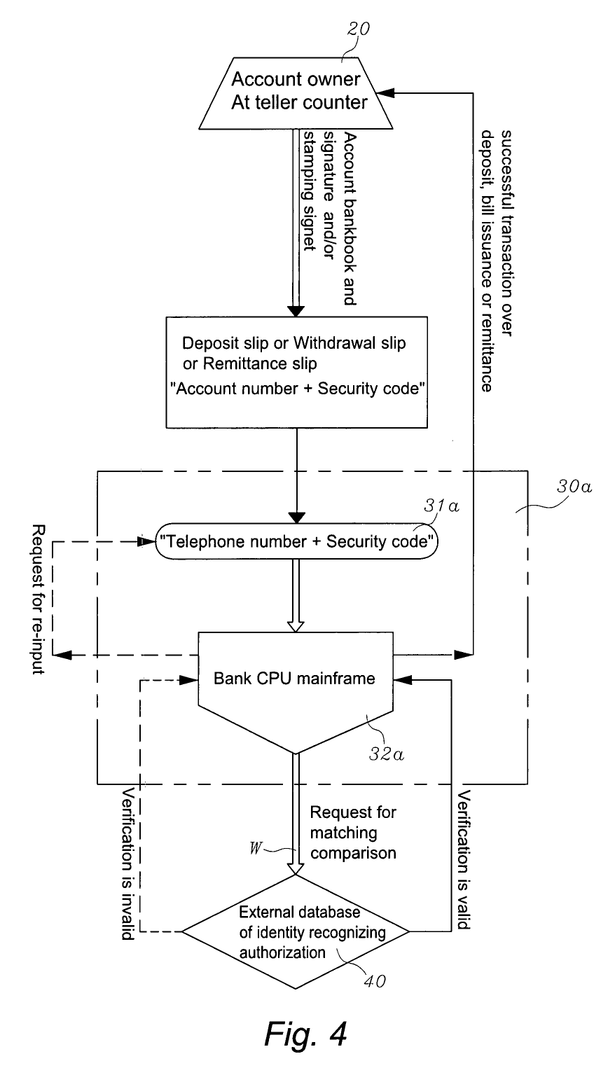

FIG. 3 and FIG. 4 are flow charts of the financial service operation at the bank teller for the present invention. When the account owner 20 carrying the account bankbook and signature and/or stamping signet goes to the bank teller in the bank 30 for a banking transaction such as a deposit, withdrawal or remittance, he/she inputs the proprietary “telephone number code and identification code” for example of [1234567 (telephone number code)+JohnLins007 (identification code)] as the identity recognizing authorization information 31 after filling in the money amount, account number and security code in the deposit slip, withdrawal slip or remittance slip. Then, the bank CPU mainframe 32 in the bank 30 will not only immediately check all the information of account name, account number, security code and the money amount with account balance but also send out simultaneously the command of “request for matching comparison” to the database of identity recognizing authorization 33 operated by the bank 30. Normally, when one set of “telephone number code and identification code” has been searched and found to completely match the set registered and stored in the database of identity recognizing authorization 33, the database of identity recognizing authorization 33 will respond with a “verification is valid” command to the bank CPU mainframe 32, which will presently send a confirmation message of “successful transaction” for the deposit, withdrawal or remittance to the account owner 20 so as to let him/her finish the transaction procedure thereof. Thereby, the financial service transaction at the bank teller is assured that a real financial transaction has been securely conducted and finished with genuine authorization by the account owner 20.

Conversely, if the “telephone number code and identification code” set has not completely matched with the set registered and stored in the database of identity recognizing authorization 33, the database of identity recognizing authorization 33 will respond with a “verification is invalid” command to the bank CPU mainframe 32, which will presently send a “request for re-input” flag to the account owner 20. In other words, except for the true account owner 20 himself/herself, or an agent entrusted by the account owner 20, who has given over the “telephone number code and identification code”, no one else can access and withdraw any money from the account of the account owner 20 at the bank teller even upon being able to present the information of account name, account number and security code but without having knowledge of the “telephone number code and identification code.” Therefore, malicious illegal banking withdrawal at the bank teller that is not really authorized by the account owner 20 will be entirely precluded.

Furthermore, if the bank 30 is reluctant to expense extra cost to build the additional database of identity recognizing authorization 33 for the present invention since the current business can be run well in smooth operation under the complete hardware and software facility in the existing internal financial computer system, software program in the bank CPU mainframe 32a of the bank 30a can easily be modified, as shown in FIG. 4, to redirect and send each command of the “request for matching comparison” to an external database of identity recognizing authorization 40 of another external computer system via a network (internet/www) W, the matching comparison function of “verification is valid” or “verification is invalid” still being achieved because the external database of identity recognizing authorization 40 is mutually connected with many banking computer systems of the other banking institutes as a network so that each the identity recognizing authorization information 31a of the proprietary “telephone number code and identification code” provided by each account owner 20, who has finished the open account application at each bank 30a, is directly registered and stored in said external database of identity recognizing authorization 40 via network (internet/www) W; Thereby, the introduction and integration the technology of the present invention into the existing internal banking computer system can be easily and immediately accomplished without any extra running cost.

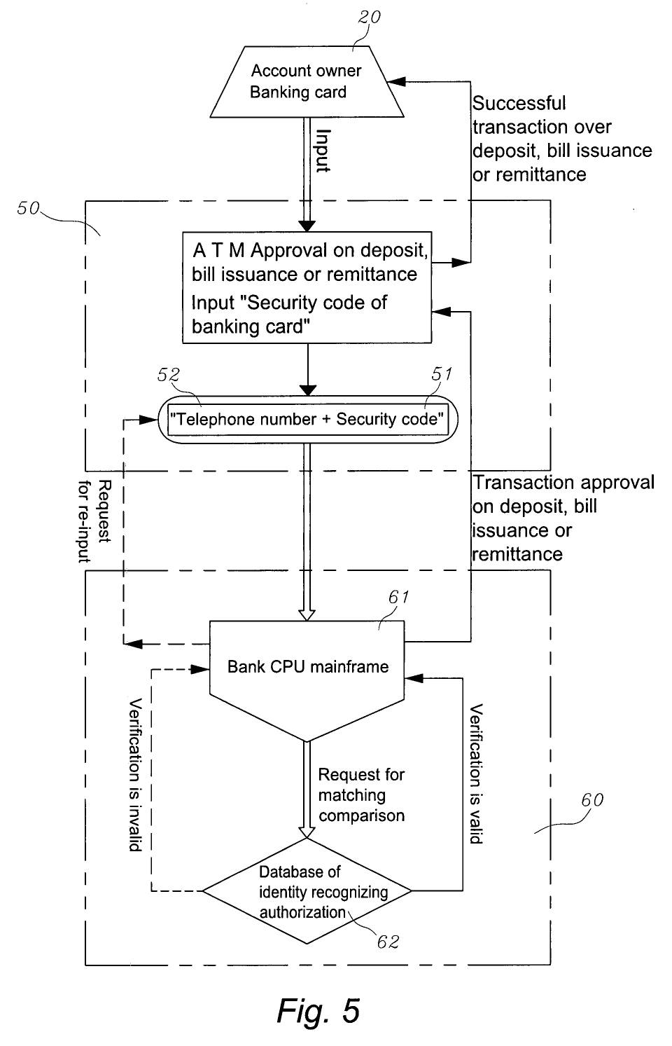

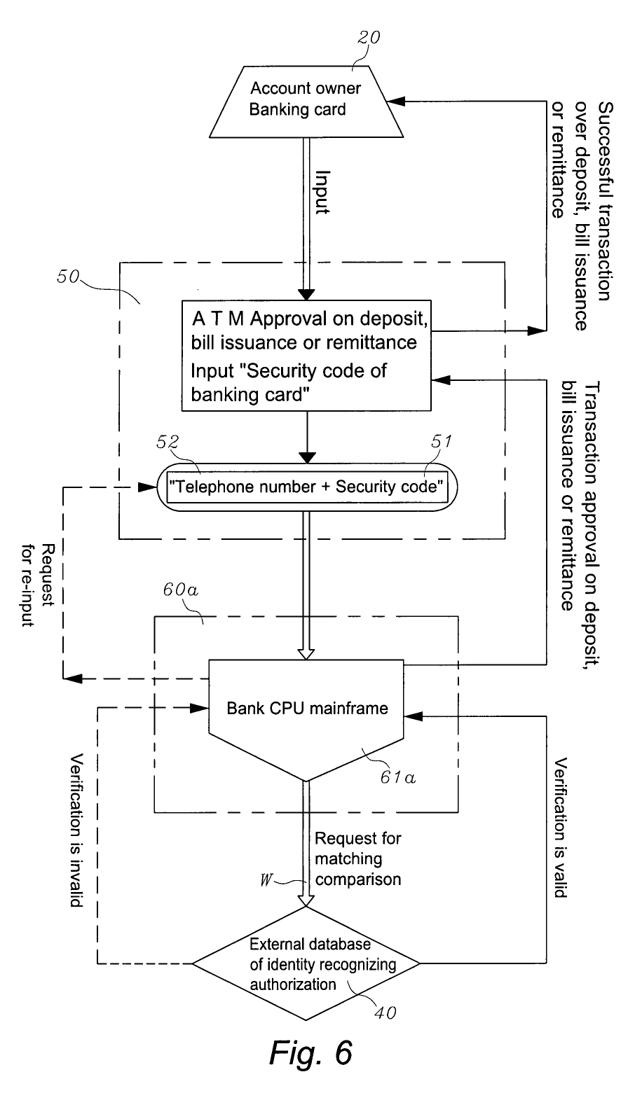

FIG. 5 and FIG. 6 are flow charts of the financial service operation at the ATM (Automatic Teller machine) for the present invention. When the account owner 20 carrying the banking card goes to the automatic teller machine (ATM) 50 to conduct a banking transaction of deposit, withdrawal or remittance, a window flagged with “telephone number code and identification code” field 51 will pop up on the screen thereof after he/she has inserted the banking card into the operating slot of the ATM and input the account number and security code thereon. At this moment, the account owner 20 must input the proprietary “telephone number code and identification code” into the “telephone number code and identification code” field 51 as the identity recognizing authorization information 52. Otherwise the subsequent procedure of this banking transaction will be unable to proceed. If the correct identity recognizing authorization information 52 of “telephone number code and identification code” for example of [1234567 (telephone number code)+JohnLins007 (identification code)] has been input, then the bank CPU mainframe 32 in the bank 30, to which the automatic teller machine 50 belongs, will not only immediately check all the information of account name, account number, security code and the money amount with account balance of said processing banking card, but also will send out simultaneously the command of “request for matching comparison” to the database of identity recognizing authorization 62 built in the bank 60. Normally, upon searching and completely matching a set of “telephone number code and identification code” with the set registered and stored in the database of identity recognizing authorization 62, the database of identity recognizing authorization 62 will respond with a “verification is valid” command to the bank CPU mainframe 61, which will presently send a confirmation message of “transaction approval on deposit, bill issuance or remittance” to the automatic teller machine 50 so as to let account owner 20 finish the transaction procedure thereof; Then, the automatic teller machine 50 automatically flags “successful transaction over deposit, bill issuance or remittance” thereon. Thereby, the financial service transaction on the automatic teller machine 50 is assured to be a real financial transaction that has been securely conducted and finished under the genuine authorization by the account owner 20.

Conversely, if the “telephone number code and identification code” set has not been completely matched with that registered and stored in the database of identity recognizing authorization 62, the database of identity recognizing authorization 62 will respond with a “verification is invalid” command to the bank CPU mainframe 61, which will presently send a “request for re-input” flag to the automatic teller machine 50 to inform the account owner 20 to re-input a new set of “telephone number code and identification code” for processing again. Therefore, anyone, who unintentionally picks or steals the banking card, cannot access and withdraw any money or transfer account from the account of the account owner 20 via the automatic teller machine 50 even when being able to present the information of account name, account number and security code but without having knowledge of the “telephone number code and identification code”. The account owner 20, whose banking card has been carelessly lost or stolen, will no longer have to worry about the monetary loss in his/her banking account due to malicious thieving withdrawal or fraudulent withdrawal, but also institution at the owner's convenience can carry out the procedure of reporting and registering the loss of the banking card to the banking, which issues said banking card, without fear of suspicion. Therefore, the criminal case of malicious stealing banking card and security code from other people will be entirely eliminated.

Moreover, as shown in the FIG. 6, the option of creating the “database of identity recognizing authorization” 62 outside of the bank 60a is available during introduction and integration of the technology of the present invention into the existing automatic teller machine 50 banking system for saving extra building cost thereof. By means of redirecting and sending each command of the “request for matching comparison” from the bank CPU mainframe 61a, which has processed the identity recognizing authorization information 52 of the proprietary “telephone number code and identification code” sent from the automatic teller machine 50 to the external database of identity recognizing authorization 40 of the other external computer system via network (internet/www) W, the matching comparison function of “verification is valid” or “verification is invalid” can also be achieved.

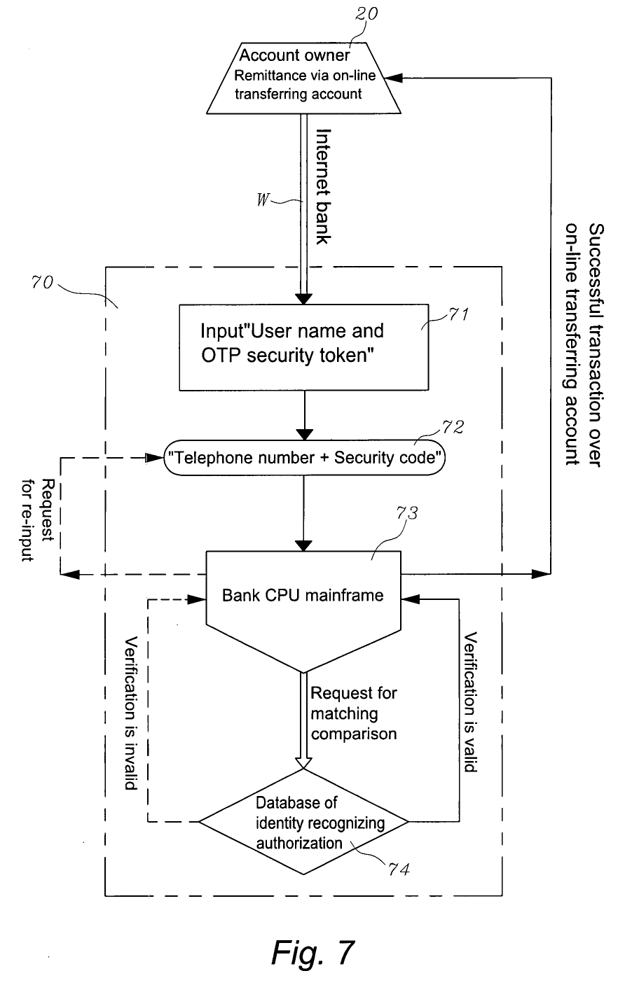

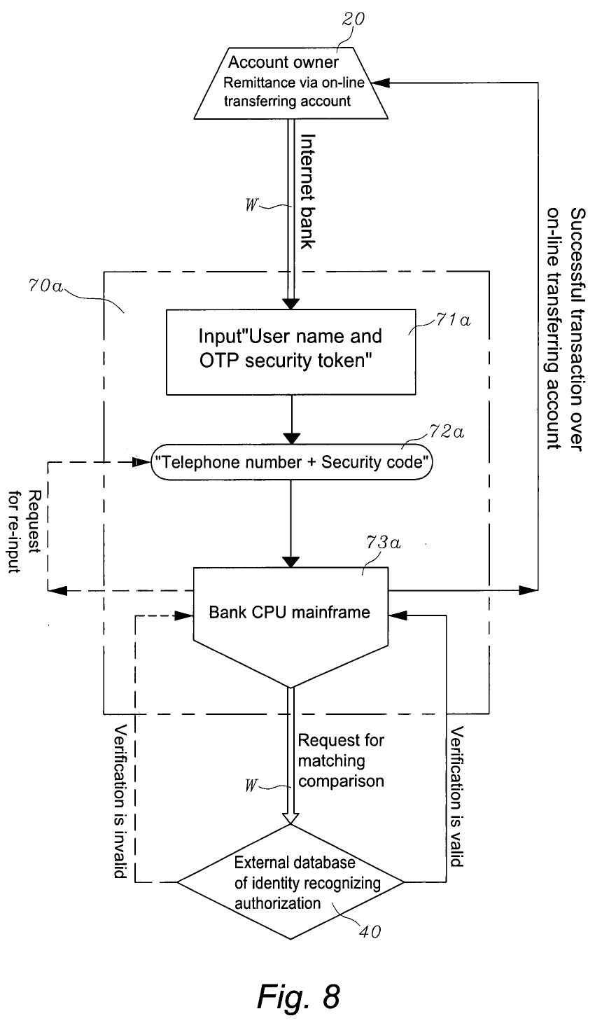

FIG. 7 and FIG. 8 are flow charts of the financial service operation at the internet remittance via on-line transferring account for the present invention. When the account owner 20 connects to the internet bank 70 via network (internet/www) W for a banking transaction involving remittance, a window flagged with an “identity recognizing authorization field” will pop up on the screen thereof after he/she has input the stipulated “user name and OTP security token” together with the money amount into the main field 71 thereat. At this moment, the account owner 20 must input the proprietary “telephone number code and identification code” for example of [1234567 (telephone number code)+JohnLins007 (identification code)] into said “identity recognizing authorization field” as the identity recognizing authorization information 72. Otherwise the subsequent procedure of this banking transaction will be unable to proceed. If the correct identity recognizing authorization information 72 of “telephone number code and identification code” has been input, then the bank CPU mainframe 73 in the bank 70 will not only immediately check all the information of “user name and OTP security token” and the money amount with account balance but also send out simultaneously the command of “request for matching comparison” to the database of identity recognizing authorization 74 built in the bank 70. Normally, when one set of “telephone number code and identification code” has been searched and completely matched with that registered and stored in the database of identity recognizing authorization 74, the database of identity recognizing authorization 74 will respond with a “verification is valid” command to the bank CPU mainframe 73, which will presently send a confirmation message of “successful transaction over on-line transferring account” to the internet bank 70 and display the message on the web-page thereof so as to let account owner 20 relay and display on the screen of his/her web-visiting tool, for example of PC or PDA and the like, to acknowledge completion of the remittance via an on-line transferring account thereon. Thereby, the financial service transaction of the remittance via the on-line transferring account is also assured to be a real financial transaction of having been certainly conducted and finished under the genuine authorization by the account owner 20.

Conversely, if the “telephone number code and identification code” set has been searched and does not completely match with that registered and stored in the database of identity recognizing authorization 74, the database of identity recognizing authorization 74 will respond with a “verification is invalid” command to the bank CPU mainframe 73, which will presently send a “request for re-input” flag to the web-page of the internet bank 70 and the screen of the web-visiting tool (for example of PC or PDA and the like) owned by the account owner 20 to inform him/her to re-input a new set of “telephone number code and identification code” for processing again. Therefore, even an expert who is highly skilled in computer technology will be unable to steal the security information related to the banking account of another person, and cannot access and withdraw any illicit money from the account of the account owner 20 via on-line transferring account even when able to present an account name, account number and security code, so long as the criminal lacks knowledge of the “telephone number code and identification code.”

Moreover, as shown in the FIG. 8, the option of creating the “database of identity recognizing authorization” 74 outside of the bank 70a is available during introduction and integration the technology of the present invention into the existing banking system for saving extra building cost thereof. By means of redirecting and sending each command of the “request for matching comparison” from the bank CPU mainframe 73a, which has processed the identity recognizing authorization information 72a of the proprietary “telephone number code and identification code” from the account owner 20 via network (internet/www) W, to the external database of identity recognizing authorization 40 of the other external computer system via network (internet/www) W, the matching comparison function of “verification is valid” or “verification is invalid” can also be achieved.

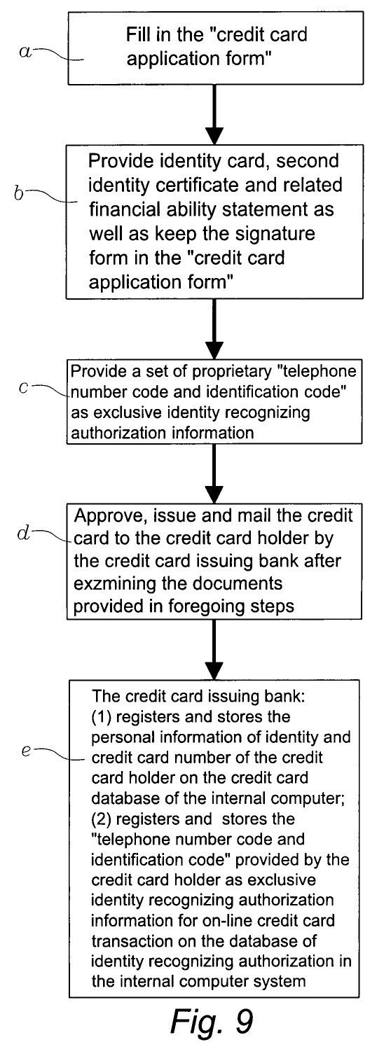

As shown in the FIG. 9, the block diagram of the financial service operation steps in the method for preventing crimes involving a finance service system using telephone number codes and identification code of the present invention comprises the steps of:

(a): The customer filling in the “credit card application form” provided by the credit card issuing bank;

(b): The customer/applicant providing the identity card, a second identity certificate and related financial ability statement as well as keep the signature form in the “credit card application form”;

(c): The customer/applicant providing a set of proprietary “telephone number code and identification code” to the credit card issuing bank as exclusive identity recognizing authorization information;

(d): The issuing bank approving, issuing and mailing the credit card to the credit card holder after examining the documents provided in the foregoing steps; and

(e): The credit card issuing bank not only registering and storing the personal information of personal identity and information of credit card number of the credit card holder on the credit card database of the internal computer, but also registering and storing the “telephone number code and identification code” provided by the credit card holder as exclusive identity recognizing authorization information for an on-line credit card transaction in the database of identity recognizing authorization in the internal computer system.

The “telephone number code” in the above-mentioned step (c) is any one of the fixed line network telephone numbers in the household or office of the applicant, namely the account owner, or a personal cellular phone number, fixed line network telephone number with country code plus area code, or personal cellular phone number with country code of the applicant/account owner. Besides, the “identification code”, which is formed from any category or combination of more than two categories of characters, numbers and symbols input from a computer keyboard, can also be arbitrarily amended or changed at anytime by the applicant, namely account owner himself/herself without any necessity for consulting with anyone in accordance with the procedures and methods set by the banking institution after being provided, registered and stored.

Moreover, the internal “database of identity recognizing authorization” in step (e) aforesaid can be changed into an “external database of identity recognizing authorization,” which is created in another external computer system out of the operating range of the internal computer system of the banking institute, so as to reduce the maintenance cost in the internal computer system of the banking institute.

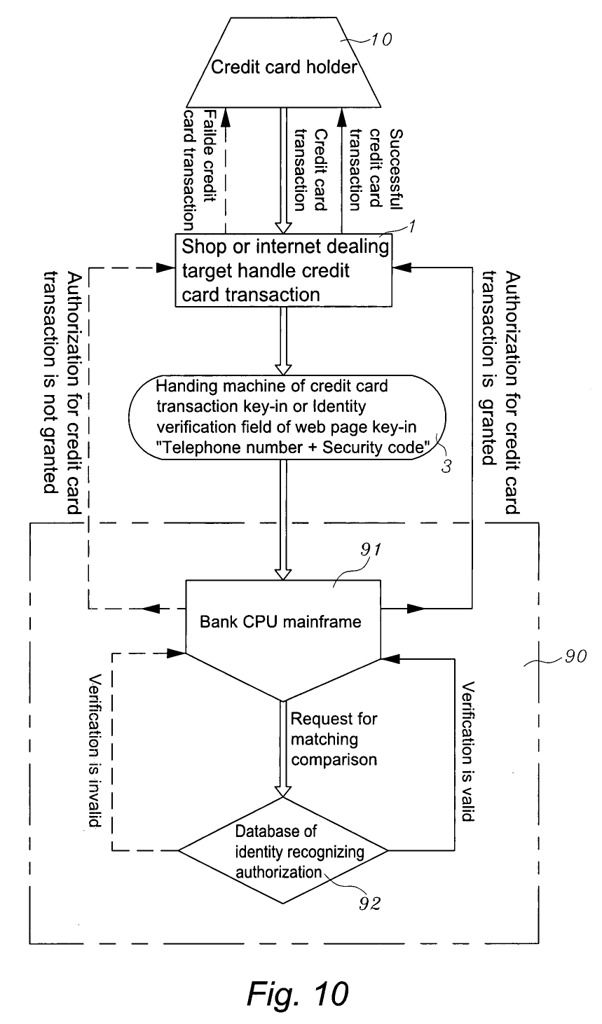

FIG. 10 is a flow chart of the embodiment at the credit card application for the present invention. When the credit card holder 10 goes to the shop or internet dealing target 1 for a “credit card transaction”, the cashier will ask the credit card holder 10 to key-in his/her proprietary “telephone number code and identification code” corresponding to his/her credit card on the handling machine of the credit card transaction as the identity recognizing authorization information 3 after scanning the credit card through the handling machine. At this moment, if the credit card holder 10 is reluctant to key-in his/her proprietary “telephone number code and identification code” as instructed by the cashier, the cashier is entitled to immediately refuse the credit card holder 10 permission to proceed with the “credit card transaction”. Likewise, when the credit card holder 10 performs the “on-line credit card transaction”, the web-page will ask the credit card holder 10 to key-in his/her proprietary “telephone number code and identification code” corresponding to his/her credit card on the handling machine of credit card transaction as the identity recognizing authorization information 3. At this moment, if the credit card holder 10 is reluctant to key-in his/her proprietary “telephone number code and identification code” as instructed by the web-page, the web-page will immediately terminate the procedure and refuse the credit card holder 10 to proceed the “on-line credit card transaction”. Thus, the algorithm aforesaid can serve as the first defensive mechanism to prevent the fraudulent online credit card transaction.

Accordingly, if the correct identity recognizing authorization information 3 of “telephone number code and identification code” has been keyed-in by the credit card holder 10 as instructed by the casher or web-page, then the bank CPU mainframe 91 in the bank 90 will not only immediately check all the information on the credit card number and the money amount with an account balance in association with the credit card holder 10, but also will send out simultaneously the command of “request for matching comparison” to the database of identity recognizing authorization 92 built in the bank 90. Normally, when one set of “telephone number code and identification code” has been searched and completely matched with that registered and stored in the database of identity recognizing authorization 92, the database of identity recognizing authorization 92 will respond a “verification is valid” command to the bank CPU mainframe 91, which will presently send a confirmation message of “authorization for credit card transaction is granted” to the shop or internet dealing target 1 so as to finish the procedure of “successful credit card transaction”. Since only the true credit card holder 10 knows the “telephone number code and identification code,” someone who unintentionally finds, or steals or forges, the credit card cannot access and withdraw any money from the account of the credit card holder 10 by a fraudulent credit card transaction without having knowledge of the “telephone number code and identification code.” Consequently, the credit card holder 10 whose credit card has been carelessly lost or stolen will no longer have to worry about the monetary loss in his/her banking account due to malicious fraudulent credit card transaction and will save the procedure of having to prove the loss of credit card to the credit card issuing bank 2, which issues said credit card. Therefore, the criminal case of malicious fraudulent credit card transaction will be entirely eliminated.

In conclusion from the disclosure hereinbefore, use of the identity recognizing authorization information of “telephone number code and identification code” in the present invention as the identity recognizing authorization information of various financial services between the bank and the account owner is novel and has great practical utility because it not only ensures the safety of each financial transaction but also effectively precludes monetary loss from the criminal behaviors of thieving withdrawal, fraudulent withdrawal or fraudulent credit card transaction. The advantages of using a “telephone number code and identification code” has also been descriptively disclosed in the patent application of “A method of searching a specific computer IP address of Internet networks using several specific telephone number with numbers in series which are arranged and assembled in sequence and coded with identification codes” submitted to the Taiwan Intellectual Property Office with filing number 93112373 on Apr. 30, 2004, by the inventor of the present invention. In addition, a website www.2udg.com, which was established in accordance with the disclosed technology for the practical embodiment of that patent application by the inventor of the present invention, has run smoothly up to now and proves to have entirely achieved the anticipated effect. However, it should be appreciated that computer hardware and software technology used to implement the website and not described herein is known to those skilled in the art and not part of the present invention.

What is claimed is:

1. A method for preventing crime involving a financial service system using telephone number codes and identification code, comprising the steps of:
(a): an applicant going to the banking institution to apply for opening a banking account by filling in an application form;
(b): the applicant providing at least one identifying document and personal information;
(c): the applicant providing a telephone number code and identification code to the banking institute as exclusive identity recognizing authorization information.
(d): the banking institute examining the identifying document, then approving and issuing an account bankbook and/or banking card.
(e): The banking institution registering and storing the personal information, a name of the account bankbook, and a number of the banking card and security code of the applicant in the database of the internal computer, and also registering and storing the telephone number code and identification code provided by the applicant as exclusive identity recognizing authorization information in a corresponding database.

2. The method of claim 1, wherein examining criterion for the application form, identifying document, and personal information are stipulated by each banking institute in accordance with laws of country to which it belongs.

3. The method of claim 1, wherein, the telephone number code is selected from the group consisting of a fixed line network telephone number in a household or office of the applicant, a personal cellular phone number, a fixed line network telephone number with country code plus area code, and a personal cellular phone number with country code of the applicant.

4. The method of claim 1, wherein the identification code is made up of any category or combination of characters, numbers, and symbols input from a computer keyboard, and may be arbitrarily amended or changed at anytime by the applicant in accordance with a procedure set by the banking institution after being provided, registered and stored.

5. The method of claim 1, wherein the exclusive identity recognizing authorization information including a “telephone number code and identification code” provided by the applicant (namely account owner) is registered and stored in an external database of identity recognizing authorization, which is created in an external computer system apart from an internal computer system of the banking institute.

6. A method for preventing crimes involving a finance service system using telephone number codes and identification code, comprising the steps of:
(a): an applicant filling in a credit card application form provided by the credit card issuing bank;
(b): the applicant providing personal information for identifying the applicant;
(c): the applicant providing a telephone number code and identification code to the credit card issuing bank as exclusive identity recognizing authorization information;
(d): the issuing bank approving, issuing and mailing the credit card to the credit card holder after examining the application form and information provided in the foregoing steps; and
(e): the credit card issuing bank registering and storing the personal information and credit card number of the credit card holder in a credit card database of an internal computer, and also registering and storing the telephone number code and the identification code provided by the credit card holder as exclusive identity recognizing authorization information for an on-line credit card transaction in a database of identity recognizing authorization.

7. The method of claim 6, wherein examining criterion for the application form, identifying document, and personal information are stipulated by each credit card issuing bank in accordance with laws of country to which it belongs.

8. The method of claim 6, wherein, the telephone number code is selected from the group consisting of a fixed line network telephone number in a household or office of the applicant, a personal cellular phone number, a fixed line network telephone number with country code plus area code, and a personal cellular phone number with country code of the applicant.

9. The method of claim 6, wherein the identification code is made up of any category or combination of characters, numbers, and symbols input from a computer keyboard, and may be arbitrarily amended or changed at anytime by the applicant in accordance with a procedure set by the credit card issuing bank after being provided, registered and stored.

10. The method of claim 6, wherein the exclusive identity recognizing authorization information including a “telephone number code and identification code” provided by the applicant (namely account owner) is registered and stored in an external database of identity recognizing authorization, which is created in an external computer system apart from the internal computer system of the card issuing bank.
